(19) United States
(12) Patent Application Publication
(10) Pub. No.: US 2026/0052462 A1
(43) Pub. Date: Feb. 19, 2026

(54) METHODS AND SYSTEMS FOR NETWORK OPTIMIZATION

(71) Applicant: Comcast Cable Communications, LLC, Philadelphia, PA (US)

(72) Inventor: Ivan ONG, MALVERN, PA (US)

(21) Appl. No.: 18/806,938

(22) Filed: Aug. 16, 2024

(51) Int. Cl. H04W 48/20; H04B 17/309; H04W 88/16

(52) U.S. Cl. CPC H04W 48/20; H04B 17/309; H04W 88/16

(57) ABSTRACT

Methods and systems for network optimization are disclosed. Wireless attribute data associated with a network may be used to determine a first path through the network for receiving downstream data of a communication session by a user device and a second path through the network for transmitting upstream data of the same communication session by the user device. Separating the transmit and receive paths of a single communication session enables the user device to transmit via the optimal transmit path and receive via the optimal receive path, even if the optimal transmit node and optimal receive node are different.

### BACKGROUND

A user can connect a user device to a network, such as a local area network, to access one or more services via the user device. The user device can connect to the network via an access point of the network. However, it may be difficult for the user to connect the user device to the access point. For example, the user device may be located too far away from the access point to establish a strong connection to the network and/or the path between the user device and the access point may be obstructed. This disclosure addresses these and other shortcomings.

### SUMMARY

Systems and methods for network optimization are described herein. A network, such as a wireless mesh network, may comprise various nodes that a user device may connect to in order to access the network. If a first node is optimal for receiving data by the user device and a second node is optimal for transmitting data by the user device, the user device may, in a single communication session, receive downstream data via the first node and transmit upstream data via the second node. Separating the transmit path from the receive path enables the user device to transmit via the optimal transmit node and receive via the optimal receive node, even if the optimal transmit node and optimal receive node are different, thereby maximizing throughput and/or capacity in the network while minimizing power consumption by the user device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

Additional advantages will be set forth in part in the description which follows or may be learned by practice. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is an example system.

FIG. 2A is an example process.

FIG. 2B is an example process.

FIG. 2C is an example process.

FIG. 3 is an example method.

FIG. 4 is an example method.

FIG. 5 is an example method.

FIG. 6 is an example method.

FIG. 7 is an example method.

FIG. 8 is an example computing device.

### DETAILED DESCRIPTION

If a user device at a premises is located too far away from an access point of a network and/or if the path between the user device and the access point is obstructed, such as by one or more walls, doors, etc., the user device may be unable to establish or maintain a strong connection with the network. To remedy these issues, one or more nodes may be added to the network to extend the coverage of the network beyond the single access point. The node(s), which may be distributed throughout the premises, may be connected to the access point and/or to each other. The user device may connect to the network (e.g., to the access point) by connecting to any of the nodes.

While expanding the network using the node(s) may make it easier for user device(s) to connect to the network, the increasing capacity and increasing throughput of evolving wireless communication standards creates new challenges for effectively serving the user device(s) connected to the expanded network. For example, the 802.11be standard aims to facilitate wireless communication at much faster speeds and larger capacities than previous wireless communication standards. As wireless communication standards continue to evolve, higher Modulation Coding Scheme (MCS) indexes may be achieved with higher frequencies (e.g., 6 GHZ), larger bandwidths (e.g., 320 MHz) may be supported, channel bandwidth can be grouped into smaller portions called resource units (RUS), higher modulation (4k QAM) may be supported, shorter guard intervals (e.g., 0.8 μs) may be used, and Orthogonal Frequency-Division Multiple Access (OFDMA) streams may be supported.

Though these features may increase the capacity and throughput of the expanded network, these features may also cause an undesirable increase in power consumption by one or more user devices connected to the network. For example, a user device may increase power consumption in an attempt to support higher, symmetrical speeds for upstream and downstream communication. The power consumption by the user device may be minimized if the user device connects to the network via the node that is associated with the best attributes (e.g., Wi-Fi characteristics), such as the best signal-to-noise ratio (SNR), the best received signal strength indicator (RSSI) from the user device perspective, the best RSSI from the access point perspective, and/or the like. However, the node that is associated with the best attributes for receiving data may be different than the node that is associated with the best attributes for transmitting data. As such, improved techniques for network optimization are needed.

Described here are improved techniques for network optimization. One or more first nodes that are optimal for receiving downstream data of a communication session by a user device may be determined. Separately, one or more nodes that are optimal for transmitting upstream data of the communication session by the user device may be determined. Separating the transmit and receive links in a single communication session enables the user device to transmit via the optimal transmit node and receive via the optimal receive node, even if the optimal transmit node and optimal receive node are different, thereby maximizing throughput and/or capacity while minimizing power consumption by the user device.

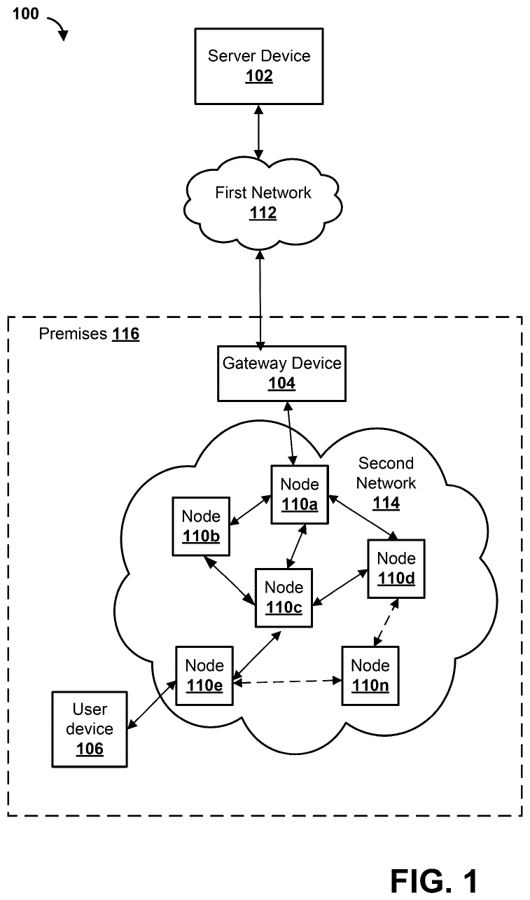

FIG. 1 is an example system 100. The system 100 may comprise a server device 102, a gateway device 104, a user device 106, or any combination thereof. It should be noted that while the singular term device is used herein, it is contemplated that some devices may be implemented as a single device or a plurality of devices (e.g., via load balancing). The server device 102, the gateway device 104, and the user device 106 may each be implemented as one or more computing devices. Any device disclosed herein may be implemented using one or more computing nodes, such as virtual machines, executed on a single device and/or multiple devices.

The gateway device 104 may comprise a network device, an access point (e.g., wireless access point), a router device, a modem, device controller (e.g., premises device controller) a combination thereof, and/or the like. The user device 106 may comprise a station, a computing device, a smart device (e.g., smart glasses, smart watch, smart phone), a mobile device, a tablet, a computing station, a laptop, a digital streaming device, a set-top box, a streaming stick, a television, and/or the like. In some scenarios, a user may have multiple user devices, such as a mobile phone, a smart watch, smart glasses, a combination thereof, and/or the like. The gateway device 104 and/or the user device 106 may be located at a premises 116. The premises 116 may be a customer premises. The server device 102 may be located external to the premises 116.

The server device 102, the gateway device 104, and the user device 106 may be communicatively coupled via one or more networks, such as a first network 112 (e.g., a wide area network) and a second network 114 (e.g., one or more local area networks). The first network 112 may comprise any of a variety of types of networks, such as, for example, a coaxial cable network, a fiber-optic cable network, a hybrid fiber-coaxial (HFC) network, a satellite transmission channel, a DSL connection, or the like. The first network 112 may comprise fiber, cable, a combination thereof. The first network 112 may comprise wired links, wireless links, a combination thereof, and/or the like. The first network 112 may comprise routers, switches, nodes, gateways, servers, modems, and/or the like. The first network 112 may comprise one or more networks, such as a wide area network (e.g., the Internet), a cellular network, a Long Term Evolution (LTE) network, one or more service entity networks, and/or the like. The user device 106 may connect to the first network 112 based on connecting to the second network 114 and/or the gateway device 104.

The second network 114 may comprise one or more networks in communication with the gateway device 104 and/or the user device 106. The second network 114 may comprise a wireless local area network (WLAN), an Institute of Electrical and Electronics Engineers (IEEE) 802.11 based network, such as an IEEE 802.11be based network, and/or any other type of wireless network or mesh network. The second network 114 may comprise one or more networks at the premises 116. The premises 116 may include an area within a coverage range (e.g., wireless range) of the second network 114. The premises 116 may comprise a property, dwelling, terminal, building, floor, and/or the like. The premises 116 may comprise different rooms, walls, door, windows, and/or the like. The user device 106 may move within the premises 116 and/or outside of the premises.

The second network 114 may comprise a wireless mesh network. The wireless mesh network may comprise a plurality of nodes 110a-n. The plurality of nodes 110a-n may be distributed across the premises 116, such that each of the plurality of nodes 110a-n are located in a different region of the premises 116. The plurality of nodes 110a-n may be in wireless communication with each other and/or the gateway device 104. The gateway device 104 may be an additional “node” of the second network 114. The gateway device 104 and the plurality of nodes 110a-n may collectively function as the “nodes” of the second network 114.

The user device 106 may connect to the first network 112 based on connecting to the gateway device 104. The user device 106 may connect to the gateway device 104 based on connecting directly to the gateway device 104. For example, the user device 106 may send data to and/or receive data directly from the gateway device 104. Additionally, or alternatively, the user device may connect to the gateway device 104 based on connecting to one or more of the plurality of nodes 110a-n. For example, the user device 106 may send data to and/or receive data from the gateway device 104 via one or more of the plurality of nodes 110a-n.

Wireless communication attributes (e.g., characteristics) associated with the second network 114 may be used to determine which node(s) (e.g., the gateway device 104 and/or one or more of the plurality of nodes 110a-n) the user device 106 should connect to in order to receive data from and transmit data to the gateway device 104. The wireless communication attributes may comprise one or more of a signal-to-noise ratio (SNR) associated with each of the plurality of nodes 110a-n, a received signal strength indicator (RSSI) associated with each of the plurality of nodes 110a-n, transmit power level, neighboring access points, an 802.11 mode, data rates from each of the plurality of nodes 110a-n, data rates from the user device 106, data rates from the gateway device 104, modulation and coding scheme (MCS) rates associated with each of the plurality of nodes 110a-n, MCS rates associated with the gateway device 104, channel utilization, bandwidth, number of spatial streams (NSS), responses to broadcast beacons associated with each of the plurality of nodes 110a-n, and/or any other attribute or characteristic of the second network 114.

The wireless communication attributes (e.g., characteristics) associated with the second network 114 may be used to determine the optimal node(s) for receiving downstream data of a communication session by the user device. The wireless communication attributes (e.g., characteristics) associated with the second network 114 may be used to separately determine the optimal node(s) for transmitting upstream data of the same communication session by the user device.

The gateway device 104 may determine the wireless communication attributes (e.g., characteristics) associated with the second network 114. The gateway device 104 may determine the wireless communication attributes associated with the second network 114 based on performing a scan of the second network 114. The wireless communication attributes associated with the second network 114 may change (e.g., vary) as the location of the user device 106 at the premises 116 changes (e.g., as the user device 106 is moved from one region of the premises 116 to another region of the premises 116). The gateway device 104 may periodically determine the data indicating the wireless communication attributes associated with the second network 114 to ensure that the wireless communication attributes reflect the most recent location of the user device 106 at the premises 116.

The gateway device 104 may send (e.g., upload) data indicating the wireless communication attributes associated with the second network 114 to the server device 102. The gateway device 104 may periodically send the data indicating the wireless communication attributes associated with the second network 114 to the server device 102 to ensure that the server device 102 continues to receive wireless communication attribute data associated with the most recent location of the user device 106 at the premises 116. The gateway device 104 may send the data indicating the wireless communication attributes associated with the second network 114 to the server device 102 using one or more management or control frames (e.g., Wi-Fi Management/Control frames).

The server device 102 may receive the data indicating the wireless communication attributes associated with the second network 114. The server device 102 may determine at least a first path through the one or more nodes 110a-n of the second network 114 for transmitting downstream data to the user device 106 (e.g., from the gateway device 104). The first path may be the optimal receive path for maximizing throughput and/or capacity, given the location of the user device 106 at the premises 116. The server device 102 may determine the first path based on the data indicating the wireless communication attributes associated with the second network 114. The first path may comprise at least a first node. The first node(s) may comprise the gateway device 104 and/or one or more of the plurality of nodes 110a-n. For example, in the example system 100 of FIG. 1, the first path may comprise Gateway Device 104-->Node 110a-->Node 110c-->Node 110e-->User Device 106.

The server device 102 may determine at least a second path through the second network 114 for transmitting upstream data from the user device 106 (e.g., to the gateway device 104). The second path may be the optimal transmit path for maximizing throughput and/or capacity, given the location of the user device 106 at the premises 116. The server device 102 may determine the second path based on the data indicating the wireless communication attributes associated with the second network 114. The second path may be different from, or the same as, the first path. The second path may comprise at least a second node. The second node(s) may comprise the gateway device 104 and/or one or more of the plurality of nodes 110a-n. The second node(s) may be different from, or the same as, the first node. For example, in the example system 100 of FIG. 1, the second path comprise User Device 106-->Node 110e-->Node 110n-->Node 110d-->Node 110a-->Gateway Device 104.

The server device 102 may determine the first path (e.g., the first node(s)) and/or the second path (e.g., the second node(s)) using an algorithm. The algorithm may comprise a function (e.g., polynomial function) that receives all the different wireless communication attributes, which may be associated with different units or magnitudes of measurement (dBm, dB, QAM rates, etc.), as logarithmic inputs. For example, the function may be equal to the sum of at least two of RSSI, SNR, transmit power level, MCS index, data rate, channel utilization, bandwidth, and number of spatial streams (NSS). RSSI may be measured in dB. SNR may be measured in dB. Transmit power level may be measured in dBm. MCS index may be measured in index numbers of 1-13 (e.g., for 802.11be and above standards). Data rate may be measured in megabits per second (Mbps). Channel Utilization may be measured as a percentage of time domain. Bandwidth may be measured in a width size of MHz. NSS may be measured by quantity of antennas available. Each of the different wireless communication attributes may assigned a weight (individually, or as an aggregated value) in the function. Each of the different wireless communication attributes may be associated with a threshold in its respective scale. The output of the function may indicate the first path (e.g., the first node(s)) and/or the second path (e.g., the second node(s)). For example, the output of the function may be used by the server device 102 to determine if the transmit path should be split from the receive path.

As one, non-limiting example, the polynomial function may be expressed as: f(n)=RSSI+SNR+Tx Pwr Level+MCS index+Data Rate+Channel Utilization+Bandwidth+NSS where: RSSI can be measured in dB; SNR can be measured in dB; Tx Pwr Level can be measured in dBm; MCS index can be measured in index numbers of 1-13 (for 802.11be and above standards), or if taking data rates then Mbps (Megabits per second); Data Rate can be measured in Mbps; Channel Utilization may be measured as a percentage of time domain; Bandwidth may be measured in width size of MHz; and NSS (Number of Spatial Streams) may be measured by number of antennas available. Each of the attributes may have different units of measurement and may have pre-defined thresholds that correlate to certain elemental criteria. Each of the attributes may be given a weight individually or as an aggregated value to help the server device 102 make the decision of which paths to choose for upstream and downstream transmissions.

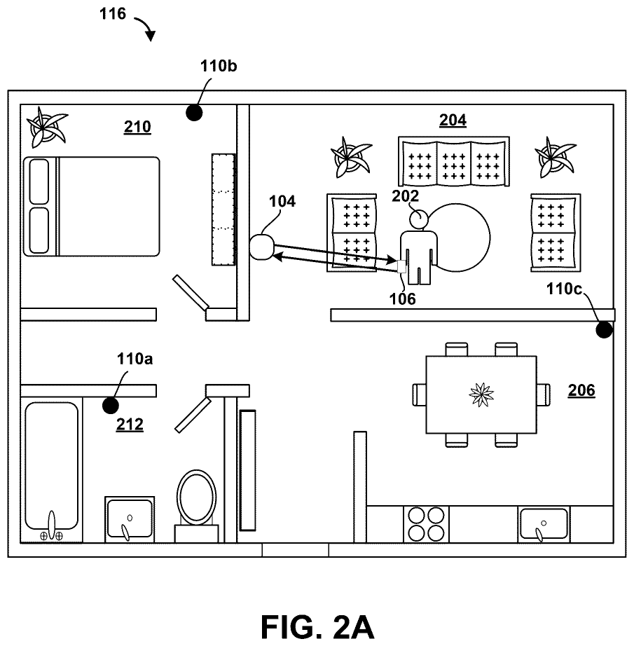

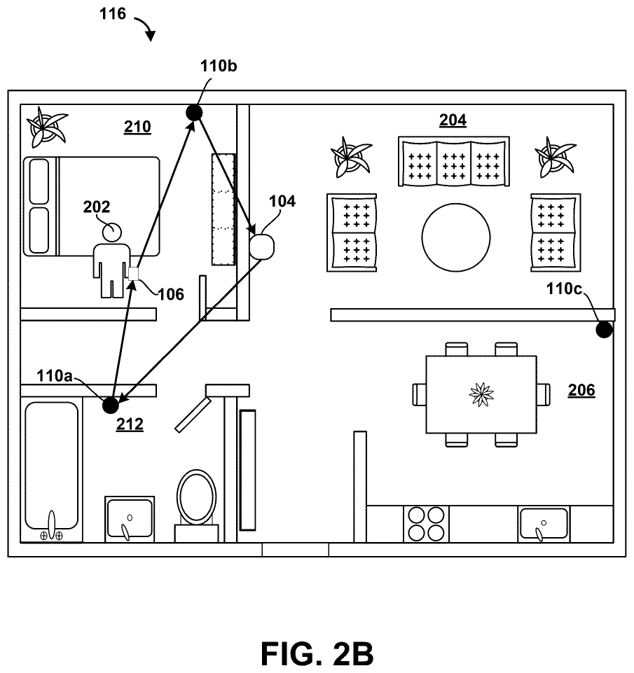

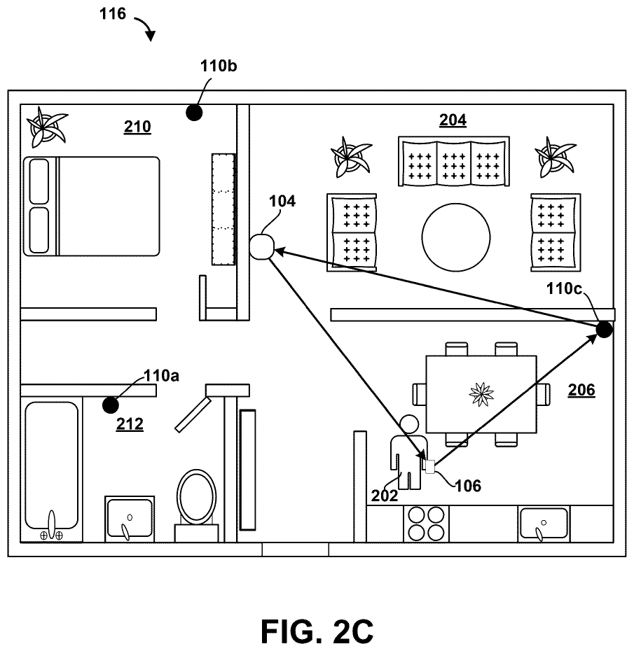

As an example, in the scenario illustrated in FIG. 2A-2C and as described in more detail below, as a client device moves through the environment and during the movement, any of the attributes may change. As the client device moves away from its originally determined node it uses for upstream or downstream transmissions, the RSSI may degrade, SNR may increase or stay constant, Tx pwr level may increase as the client device struggles to continue to transmit back to that original node, MCS schemes may increase or decrease depending on NSS availability, BW may reduce, Channel Utilization may increase, and Data rate may decrease. Given these example changes, thresholds may be set for each attribute in its respective scale, and each attribute may be assigned a weight. These factors may all assist in determining when to switch upstream and downstream paths.

The server device 102 may make the determination of the second path and/or second node separately from (e.g., independently from) the determination of the first path and/or first node. Making the determination of the second path and/or second node separately from the determination of the first path and/or first node enables the transmit and receive paths in a single communication session to be separated. Separating the transmit and receive paths in a single communication session may enable the user device 106 to transmit via the optimal transmit node and receive via the optimal receive node, even if the optimal transmit node and optimal receive node are different.

The server device 102 may send an indication to the gateway device 104. The indication may indicate the determined first path (e.g., the first node(s)) and/or the determined second path (e.g., the second node(s)). The server device 102 may send the indication to the gateway device 104 to cause the user device 106 to receive downstream data of a communication session via the first path (e.g., the first node(s)) and to send upstream data of the communication session via the second path (e.g., the second node(s)). For example, the server device 102 may cause a downstream path to be implemented by indicating, to the gateway device 104, that the first node(s) should attach to one another to form the first path for downstream communications. The server device 102 may indicate, to the gateway device 104, that if one of the first node(s) is connected to a different node (e.g., a node that is not on the determined first path), that node should disassociate from the different node and instead attach itself to a node that is on the determined first path. The server device 102 may cause an upstream path to be implemented by indicating, to the gateway device 104, that the second node(s)) should attach to one another to form the second path for downstream communications. The server device 102 may indicate, to the gateway device 104, that if one of the second node(s) is connected to a different node (e.g., a node that is not on the determined second path), that node should disassociate from the different node and instead attach itself to a node that is on the determined second path. The gateway device 104 may send the indicated path to the user device 102 and to the one or more nodes, which may use the indication of the path to establish connections for upstream and downstream communications the node(s) indicated as the next upstream and next downstream node in the path. The connections between the user device 106, the one or more nodes, and the gateway device needed to establish the indicated upstream and downstream paths may be established in accordance with the 802.11 protocol. Alternatively, the connections may be established in accordance with another wireless protocol.

The gateway device 104 may receive the indication. The gateway device 104 may determine the first path (e.g., the first node(s)) and/or the second path (e.g., the second node(s)). The gateway device 104 may determine the first path (e.g., the first node(s)) and/or the second path (e.g., the second node(s)) based on the indication. The gateway device 104 may instruct the first node(s) and/or the user device 106 to establish attachments or connections to each other (e.g., using a wireless protocol, such as an 801.11 protocol) to form the first path for downstream communications. If one of the first node(s) and/or the user device 106 is connected to a different node (e.g., a node that is not on the determined first path), the gateway device 104 may instruct the node and/or the user device 106 to disassociate from the different node and instead attach itself to a node that is on the determined first path. The gateway device 104 may instruct the second node(s) and/or the user device 106 to establish attachments or connections to each other (e.g., using a wireless protocol, such as an 801.11 protocol) to form the second path for upstream communications. If one of the first node(s) and/or the user device 106 is connected to a different node (e.g., a node that is not on the determined first path), the gateway device 104 may instruct the node to disassociate from the different node and instead attach itself to a node that is on the determined first path.

The gateway device 104 may send a message to the user device 106 based on (e.g., in response to) determining the first path (e.g., the first node(s)) and/or the second path (e.g., the second node(s)). The message may instruct the user device 106 to use the first path (e.g., the first node(s)) for receiving downstream data of a communication session. For example, the message may instruct the user device 106 to associate itself with (e.g., connect to) the first node(s) for receiving downstream data of the communication session from the gateway device 104. The message may instruct the user device 106 to use the second path (e.g., the second node(s)) for transmitting upstream data of the same communication session. For example, the message may instruct the user device 106 to associate itself with (e.g., connect to) the second node(s) for transmitting upstream data of the communication session to the gateway device 104.

The user device 106 may receive downstream data of a communication session via the first path (e.g., the first node(s)) based on (e.g., as a result of) the first node(s) and/or the user device 106 establishing the attachments or connections to each other to form the first path. The user device 106 may send upstream data of the same communication session via the second path (e.g., the second node(s)) based on (e.g., as a result of) the second node(s) and/or the user device 106 establishing the attachments or connections to each other to form the second path.

Instead of the gateway device 104 sending the data indicating the wireless communication attributes associated with the second network 114 to the server device 102 and relying on the server device 102 to determine the first path (e.g., the first node(s)) and/or the second path (e.g., the second node(s)), the gateway device 104 itself may use the data indicating the wireless communication attributes associated with the second network 114 to determine the first path (e.g., the first node(s)) and/or the second path (e.g., the second node(s)).

Additionally, or alternatively, any one of the nodes 110a-n may perform the determination of the first path (e.g., the first node(s)) and/or the second path (e.g., the second node(s)). For example, one of the nodes 110a-n may receive downstream data from the gateway device 104. Based on receiving the downstream data from the gateway device 104, the node may use the data indicating the wireless communication attributes associated with the second network 114 to determine the best first path, which may include one or more additional nodes, from the node to the user device 106. The first path may be different from the second path (e.g., the second node(s)). Likewise, one of the nodes 110a-n may receive upstream data from the user device 106. Based on receiving the upstream data from the user device 106, the node may use the data indicating the wireless communication attributes associated with the second network 114 to determine the best second path, which may include one or more additional nodes, from the node to the gateway device 104. The second path may be different from the first path.

The server device 102, the gateway device 104, and/or one of the nodes 110a-n may determine the first path (e.g., the first node(s)) for transmitting downstream data of the communication session to the user device 106 and the second path (e.g., the second node(s)) for transmitting upstream data of the communication session to the gateway device 104 at different times. For example, the first path may be determined at a first time. The first path, determined at the first time, may be different from the second path that is being used, at the first time, to transmit upstream data of the communication session. The second path may be determined at a second time. The second time may occur before, or after, the first time. The second path, determined at the second time, may be different from the first path that is being used, at the second time, to transmit downstream data of the communication session.

If more than one user device is connected to the second network 114, the gateway device 104 may determine wireless attribute data associated with the second network 114 for each of the connected user devices. The wireless attribute data associated with the second network 114 for a first device located in a first area of the premises 116 may be different than the wireless attribute data associated with the second network 114 for a second user device located in a second area of the premises 116. The wireless attribute data associated with the second network 114 for the first user device may be different than the wireless attribute data associated with the second network 114 for the second user device, even if the two user devices are located at the same area of the premises 116, as each of the connected user devices may be associated with different radio frequency (RF) attributes. The RF attributes associated with a user device may be dependent on the user device hardware and the user device connection behavior. For example, a first user device, such as a laptop computer, may have at least a 3×3 antenna. A second user device, such as a mobile phone, may have a 2×2 antenna. A third user device, such as a wireless printer, may utilize a 1×1 antenna on 802.11n legacy mode (e.g., on 2.4 GHZ). The first user device, the second user device, and the third user device may each be associated with different RF attributes.

The server device 102, or the gateway device 104, may use the data indicating the wireless communication attributes for each of the connected user devices to determine which node(s) each of the connected user devices should use to receive downstream data and which node(s) each of the connected user devices should use to transmit upstream data. The server device 102 may determine that more than one of the connected user devices should use the same node(s) for receiving downstream data and that more than one of the connected user devices should use the same node(s) to transmit upstream. For example, if more than one, or all, of the connected user devices are located in close proximity of one another, the server device 102, or the gateway device 104, may be more likely to determine that more than one of the connected user devices should use the same node(s) for receiving downstream data and/or that more than one of the connected user devices should use the same node(s) to transmit upstream data.

To ensure that lower priority user devices, such as wireless printers, do not constrain the ability of higher priority user devices, such as laptop computers and/or mobile phones, to transmit or receive data, a weight (e.g., priority score) can be assigned to each user device. The weight assigned to a particular user device can indicate a priority associated with that user device. The weight can be assigned by a user. The weight can be automatically assigned based on a type of the user device. If the server device 102, or the gateway device 104, determines that two or more user devices should use the same node(s) for receiving downstream data and/or the same node(s) to transmit upstream data, the lower priority user device(s) (e.g., the user device(s) associated with lower weights) may be instructed to receive downstream data and/or transmit upstream data via at least one different, less optimal node to ensure that the higher priority user devices have optimal transmit and receive capabilities.

FIGS. 2A-C are diagrams of an example process for network optimization. FIG. 2A shows a user 202 located at the premises 116. The premises 116 may comprise a plurality of rooms (e.g., regions, areas), such as a living room 204, a dining room 206, a bedroom 210, a bathroom 212, and/or the like. The premises 116 may comprise the second network 114 (e.g., the gateway device 104 and the nodes 110a-c) and the user device 106. The gateway device 104 may form a wireless mesh network with the plurality of nodes 110a-c. The gateway device 104 may be in communication with a server device (e.g., the server device 102) located external to the premises 116.

The user device 106 may be located at a first area, such as in the living room 204, of the premises 116. For example, the user 202 may be using the user device 106 while the user 202 is located in the living room 204. The gateway device 104 may determine first wireless communication attributes (e.g., characteristics) associated with the second network 114. The first wireless communication attributes may be indicative of the wireless communication attributes associated with the second network 114 while the user device 106 is located at the first area.

The first wireless communication attributes may comprise one or more of a signal-to-noise ratio (SNR) associated with each of the nodes 110a-c, a received signal strength indicator (RSSI) associated with each of the nodes 110a-c, transmit power level, neighboring access points, an 802.11 mode, data rates from each of the nodes 110a-c, data rates from the user device 106 located at the first area of the premises 116, data rates from the gateway device 104, modulation and coding scheme (MCS) rates associated with each of the nodes 110a-c, MCS rates associated with the gateway device 104, channel utilization, bandwidth, NSS, responses to broadcast beacons associated with each of the nodes 110a-c, and/or any other attribute or characteristic of the second network 114.

The gateway device 104 may send (e.g., upload) data indicating the first wireless communication attributes associated with the second network 114 to the remote server device. The gateway device 104 may send the data indicating the first wireless communication attributes to the remote server device using one or more management or control frames (e.g., Wi-Fi Management/Control frames).

The server device may receive the data indicating the first wireless communication attributes associated with the second network 114. The server device may use the data indicating the first wireless communication attributes to determine which node(s) the user device 106 should use to receive downstream data and which node(s) the user device 106 should use to transmit upstream data while the user device 106 is located at the first area of the premises 116.

In the example of FIG. 2A, the server device may determine that the gateway device 104 is the optimal node for both receiving downstream data and transmitting upstream data while the user device 106 is located at the first area of the premises 116. The server device may send an indication to the gateway device 104. The indication may indicate that gateway device 104 is the optimal node for both receiving downstream data and transmitting upstream data while the user device 106 is located at the first area of the premises 116. For example, the server device may cause the downstream path to be implemented by indicating, to the gateway device 104, that the gateway device 104 should directly attach to the user device 106 to form a path for downstream communications. The server device may cause the upstream path to be implemented by indicating, to the user device 106, that the user device 106 should directly attach to the gateway device 104 to form a path for upstream communications.

The gateway device 104 may receive the indication. The gateway device 104 may attach itself to the user device 106 to form the path for downstream communications based on (e.g., in response to) receiving the indication. The gateway device 104 may attach itself to the user device 106 (or instruct the user device 106 to attach itself with the gateway device 104) to form the path for upstream communications based on (e.g., in response to) receiving the indication. The user device 106 may receive downstream data of a communication session via the gateway device 104. The user device 106 may send upstream data of the same communication session via the gateway device 104.

As the user device 106 is moved throughout the premises, the wireless communication attributes associated with the second network 114 may change. For example, as the user device 106 is moved away from the gateway device 104, the RSSI may degrade, the SNR may increase, the transmit power level may increase as the user device 106 struggles to transmit data back to the gateway device 104, MCS schemes may increase or decrease depending on NSS availability, bandwidth may decrease, channel utilization may increase, and/or data rate may decrease.

If the wireless communication attributes associated with the second network 114 change, the node(s) that the user device 106 should use to receive downstream data and/or the node(s) that the user device 106 should use to transmit upstream data may change. In the example of FIG. 2B, the user 202 may carry the user device 106 to a second area, such as to the bedroom 210, of the premises 116. The gateway device 104 may determine second wireless communication attributes (e.g., characteristics) associated with the second network 114. The second wireless communication attributes may be indicative of the wireless communication attributes associated with the second network 114 while the user device 106 is located at the second area. The second wireless communication attributes may be different from the first wireless communication attributes.

The second wireless communication attributes may comprise one or more of a signal-to-noise ratio (SNR) associated with each of the nodes 110a-c, a received signal strength indicator (RSSI) associated with each of the nodes 110a-c, transmit power level, neighboring access points, an 802.11 mode, data rates from each of the nodes 110a-c, data rates from the user device 106 located at the second area of the premises 116, data rates from the gateway device 104, modulation and coding scheme (MCS) rates associated with each of the nodes 110a-c, MCS rates associated with the gateway device 104, channel utilization, bandwidth, number of spatial streams (NSS), responses to broadcast beacons associated with each of the nodes 110a-c, and/or any other attribute or characteristic of the second network 114.

The gateway device 104 may send (e.g., upload) data indicating the second wireless communication attributes associated with the second network 114 to the remote server device. The gateway device 104 may send the data indicating the second wireless communication attributes to the remote server device using one or more management or control frames (e.g., Wi-Fi Management/Control frames).

The server device may receive the data indicating the second wireless communication attributes associated with the second network 114. The server device may use the data indicating the second wireless communication attributes to determine which node(s) the user device 106 should use to receive downstream data and which node(s) the user device 106 should use to transmit upstream data while the user device 106 is located at the second area of the premises 116. In the example of FIG. 2B, the server device may determine that the node 110a is the optimal node for receiving downstream data while the user device 106 is located at the second area of the premises 116 and that the node 110b is the optimal node for transmitting upstream data while the user device 106 is located at the first area of the premises 116.

The server device may send an indication to the gateway device 104. The indication may indicate that the node 110a is the optimal node for receiving downstream data while the user device 106 is located at the second area of the premises 116 and that the node 110b is the optimal node for transmitting upstream data while the user device 106 is located at the second area of the premises 116. For example, the server device may cause the downstream path to be implemented by indicating, to the gateway device 104, that the gateway device 104 should attach to the node 110a to form a path for downstream communications. The server device may cause the upstream path to be implemented by indicating, to the gateway device 104, that the gateway device 104 should attach to the node 110b to form a path for upstream communications.

The gateway device 104 may receive the indication. The gateway device 104 may attach itself to the node 110a to form the path for downstream communications based on (e.g., in response to) receiving the indication. The gateway device 104 may attach itself to the node 110b to form the path for downstream communications based on (e.g., in response to) receiving the indication. The user device 106 may receive downstream data of a communication session from the gateway device 104 via the node 110a. The user device 106 may send upstream data of the same communication session to the gateway device 104 via the node 110b. Separating the transmit and receive paths in a single communication session may enable the user device 106 to transmit via the optimal transmit node (e.g., the node 110b) and receive via the optimal receive node (e.g., the node 110a), even though the optimal transmit node and optimal receive node are different.

As the user device 106 continues to be moved throughout the premises, the wireless communication attributes associated with the second network 114 may continue to change. In the example of FIG. 2C, the user 202 may carry the user device 106 to a third area, such as to the dining room 206, of the premises 116. The gateway device 104 may determine third wireless communication attributes (e.g., characteristics) associated with the second network 114. The third wireless communication attributes may be indicative of the wireless communication attributes associated with the second network 114 while the user device 106 is located at the third area. The third wireless communication attributes may be different from the second wireless communication attributes and/or the first wireless communication attributes.

The third wireless communication attributes may comprise one or more of a signal-to-noise ratio (SNR) associated with each of the nodes 110a-c, a received signal strength indicator (RSSI) associated with each of the nodes 110a-c, transmit power level, neighboring access points, an 802.11 mode, data rates from each of the nodes 110a-c, data rates from the user device 106 located at the third area of the premises 116, data rates from the gateway device 104, modulation and coding scheme (MCS) rates associated with each of the nodes 110a-c, MCS rates associated with the gateway device 104, channel utilization, bandwidth, number of spatial streams (NSS), responses to broadcast beacons associated with each of the nodes 110a-c, and/or any other attribute or characteristic of the second network 114.

The gateway device 104 may send (e.g., upload) data indicating the third wireless communication attributes associated with the second network 114 to the remote server device. The gateway device 104 may send the data indicating the third wireless communication attributes to the remote server device using one or more management or control frames (e.g., Wi-Fi Management/Control frames).

The server device may receive the data indicating the third wireless communication attributes associated with the second network 114. The server device may use the data indicating the third wireless communication attributes to determine which node(s) the user device 106 should use to receive downstream data and which node(s) the user device 106 should use to transmit upstream data while the user device 106 is located at the third area of the premises 116. In the example of FIG. 2C, the server device may determine that gateway device 104 is the optimal node for receiving downstream data while the user device 106 is located at the third area of the premises 116 and that the node 110c is the optimal node for transmitting upstream data while the user device 106 is located at the third area of the premises 116.

The server device may send an indication to the gateway device 104. The indication may indicate that the gateway device 104 is the optimal node for receiving downstream data while the user device 106 is located at the third area of the premises 116 and that the node 110c is the optimal node for transmitting upstream data while the user device 106 is located at the third area of the premises 116. For example, the server device may cause the downstream path to be implemented by indicating, to the gateway device 104, that the gateway device 104 should connect directly to the user device 106 to form a path for downstream communications. The server device may cause the upstream path to be implemented by indicating, to the gateway device 104, that the gateway device 104 should attach to the node 110c to form a path for upstream communications. The server device may cause the user device 106 to accept the direct attachment to the gateway device 104 for downstream communications, and may cause the user device 106 similarly to attach to the node 110c for upstream communications.

The gateway device 104 may receive the indication. The gateway device 104 may attach itself directly to the user device 106 to form the path for downstream communications based on (e.g., in response to) receiving the indication. The gateway device 104 may attach itself to the node 110c to form the path for downstream communications based on (e.g., in response to) receiving the indication. The user device 106 may accept the direct attachment to the gateway device 104 for the downstream communications, and the user device 106 may similarly be caused to attach itself to the node 110c for upstream communications. The user device 106 may receive downstream data of a communication session directly from the gateway device 104. The user device 106 may send upstream data of the same communication session to the gateway device 104 via the node 110c. Separating the transmit and receive paths in a single communication session may enable the user device 106 to transmit via the optimal transmit node (e.g., the node 110c) and receive via the optimal receive node (e.g., the gateway device 104), even though the optimal transmit node and optimal receive node are different.

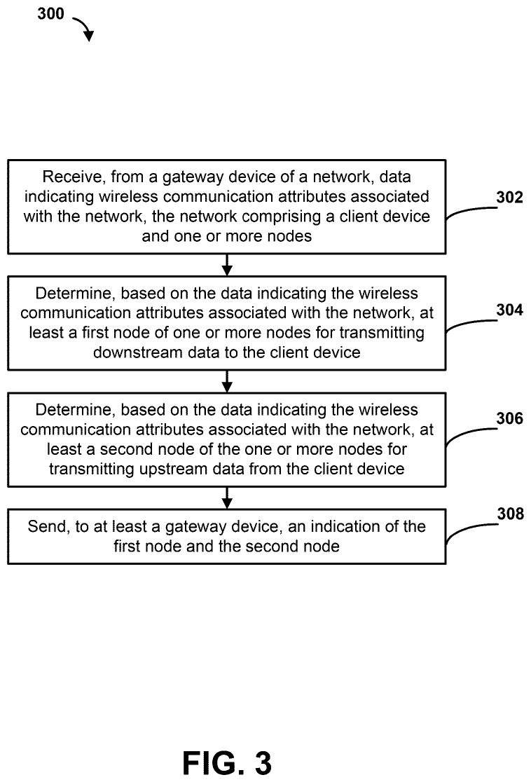

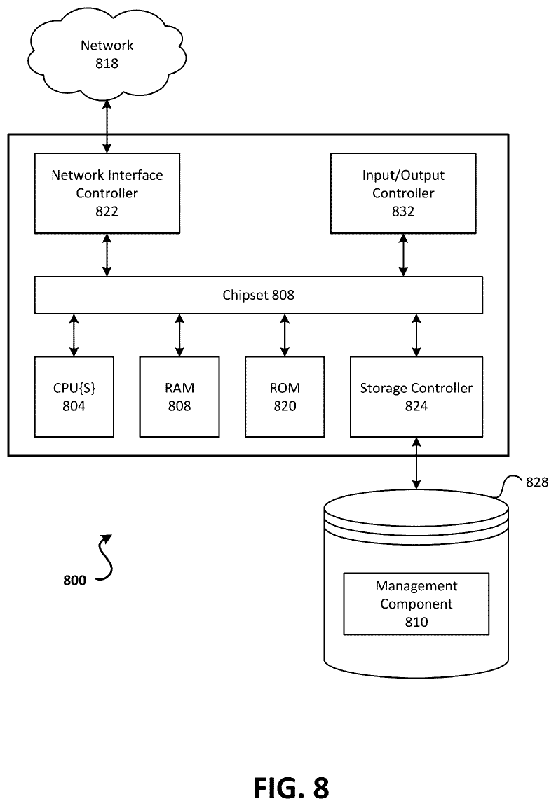

FIG. 3 is an example method 300. The method 300 may comprise a computer implemented method for network optimization. A system and/or computing environment, such as the system 100 of FIG. 1 and/or the computing environment of FIG. 8, may be configured to perform the method 300. For example, the server device 102 of FIG. 1 may be configured to perform the method 300.

At 302, data indicating wireless communication attributes associated with a network may be received. The data indicating the wireless communication attributes associated with the network may be received from a gateway device of a network. The network may be located at a premises. The data indicating the wireless communication attributes associated with the network may be received by a server device located external to the premises. The network may comprise a client device and one or more nodes. The one or more nodes may comprise the gateway device. The wireless communication attributes may be associated with a location of the client device at the premises. The wireless communication attributes may change (e.g., vary) as the client device is moved around the premises.

The wireless communication attributes may comprise one or more of a signal-to-noise ratio (SNR) associated with each of the one or more nodes, a received signal strength indicator (RSSI) associated with each of the one or more nodes, transmit power level, neighboring access points, an 802.11 mode, data rates from each of the one or more nodes, data rates from the client device, modulation and coding scheme (MCS) rates associated with each of the one or more nodes, channel utilization, bandwidth, number of spatial streams (NSS), and/or responses to broadcast beacons associated with each of the one or more nodes.

At 304, at least a first node of the one or more nodes for transmitting downstream data to the client device may be determined. The first node may be determined based on the data indicating the wireless communication attributes associated with the network. The first node may comprise the node for transmitting downstream data to the client device that maximizes throughput and/or capacity, given the location of the client device at the premises. At 306, at least a second node of the one or more nodes for receiving upstream data by the client device may be determined. The second node may be determined based on the data indicating the wireless communication attributes associated with the network. The second node may comprise the node for receiving upstream data by the client device that maximizes throughput and/or capacity, given the location of the client device at the premises. The second node may be different from, or the same as, the first node.

At 308, an indication may be sent to at least the gateway device. The indication may comprise an indication of the first node and the second node. Sending the indication to the gateway device may cause the client device to receive downstream data of a communication session via the first node and to send upstream data of the same communication session via the second node. Separating the transmit and receive links in the single communication session enables the client device to transmit via the optimal transmit node(s) and receive via the optimal receive node(s), even if the optimal transmit node(s) and optimal receive node(s) are different, thereby maximizing throughput and/or capacity while minimizing power consumption by the client device.

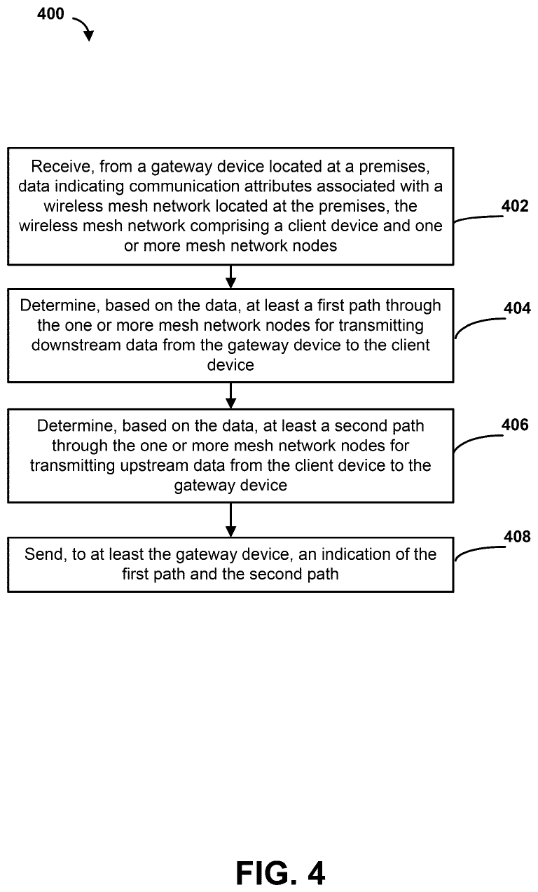

FIG. 4 is an example method 400. The method 400 may comprise a computer implemented method for network optimization. A system and/or computing environment, such as the system 100 of FIG. 1 and/or the computing environment of FIG. 8, may be configured to perform the method 400. For example, the server device 102 of FIG. 1 may be configured to perform the method 400.

At 402, data indicating communication attributes associated with a wireless mesh network may be received. The data indicating the communication attributes associated with the wireless mesh network may be received from a gateway device of a network. The wireless mesh network may be located at a premises. The data indicating the communication attributes associated with the wireless mesh network may be received by a server device located external to the premises. The wireless mesh network may comprise a client device and one or more mesh network nodes. The one or more mesh network nodes may comprise the gateway device. The communication attributes may be associated with a location of the client device at the premises. The communication attributes may change (e.g., vary) as the client device is moved around the premises.

The communication attributes may comprise one or more of a signal-to-noise ratio (SNR) associated with each of the one or more mesh network nodes, a received signal strength indicator (RSSI) associated with each of the one or more mesh network nodes, transmit power level, neighboring access points, an 802.11 mode, data rates from each of the one or more mesh network nodes, data rates from the client device, modulation and coding scheme (MCS) rates associated with each of the one or more mesh network nodes, channel utilization, bandwidth, number of spatial streams (NSS), and/or responses to broadcast beacons associated with each of the one or more mesh network nodes.

At 404, at least a first path through the one or more mesh network nodes for transmitting downstream data to the client device may be determined. The first path may be determined based on the data indicating the communication attributes associated with the wireless mesh network. The first path may comprise at least one first mesh network nodes. The first path may comprise the path through the one or more mesh network nodes for transmitting downstream data to the client device that maximizes throughput and/or capacity, given the location of the client device at the premises.

At 406, at least a second path through the one or more mesh network nodes for receiving upstream data from the client device may be determined. The second path may be determined based on the data indicating the communication attributes associated with the wireless mesh network. The second path may comprise at least one second mesh network nodes. The second path may comprise the path through the one or more mesh network nodes for receiving data from the client device that maximizes throughput and/or capacity, given the location of the client device at the premises. The second path may be different from, or the same as, the first path. The second node may be different from, or the same as, the first node.

At 408, an indication may be sent to at least the gateway device. The indication may comprise an indication of the first path and the second path. Sending the indication to the gateway device may cause the client device to receive downstream data of a communication session via the first path and to send upstream data of the same communication session via the second path. Separating the transmit and receive paths in the single communication session enables the client device to transmit via the optimal transmit path and receive via the optimal receive path, even if the optimal transmit path and optimal receive path are different, thereby maximizing throughput and/or capacity while minimizing power consumption by the client device.

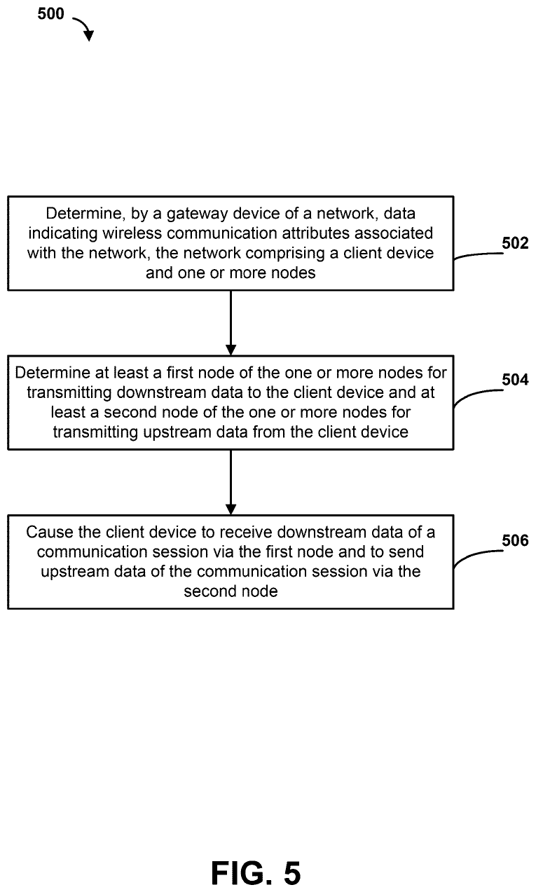

FIG. 5 is an example method 500. The method 500 may comprise a computer implemented method for network optimization. A system and/or computing environment, such as the system 100 of FIG. 1 and/or the computing environment of FIG. 8, may be configured to perform the method 500. For example, the gateway device 104 of FIG. 1 may be configured to perform the method 500.

At 502, data indicating wireless communication attributes associated with a network may be determined. The network may comprise a client device and one or more nodes. The one or more nodes may comprise a gateway device. The network may be located at a premises. Determining the data indicating wireless communication attributes associated with the network may comprise performing a scan of the network. The determined wireless communication attributes may be associated with a location of the client devices at the premises. The wireless communication attributes may change (e.g., vary) as the location of the client device at the premises changes.

The wireless communication attributes may comprise one or more of a signal-to-noise ratio (SNR) associated with each of the one or more nodes, a received signal strength indicator (RSSI) associated with each of the one or more nodes, transmit power level, neighboring access points, an 802.11 mode, data rates from each of the one or more nodes, data rates from the client device, modulation and coding scheme (MCS) rates associated with each of the one or more nodes, channel utilization, bandwidth, number of spatial streams (NSS), and/or responses to broadcast beacons associated with each of the one or more nodes.

The data indicating the wireless communication attributes associated with the network may be sent to at least one server device located external to the premises. The data indicating the wireless communication attributes associated with the network may be sent to the at least one server device using one or more management or control frames (e.g., Wi-Fi Management/Control frames).

At 504, at least a first node of the one or more nodes for transmitting downstream data to the client device and at least a second node of the one or more nodes for transmitting upstream data from the client device may be determined. The first node and the second node may be determined based on sending the data indicating the wireless communication attributes associated with the network to the at least one server device. For example, an indication of the first node and the second node may be received based on (e.g., in response to) sending the data indicating the wireless communication attributes associated with the network to the at least one server device. The first node and the second node may be determined based on the indication.

The first node may comprise the node for transmitting downstream data to the client device that maximizes throughput and/or capacity, given the location of the client device at the premises. The second node may comprise the node for receiving upstream data by the client device that maximizes throughput and/or capacity, given the location of the client device at the premises. The second node may be different from, or the same as, the first node.

At 506, the client device may be caused to receive downstream data of a communication session via the first node and to send upstream data of the same communication session via the second node. Causing the client device to receive downstream data of a communication session via the first node and to send upstream data of the same communication session via the second node may comprise instructing the first node and/or the client device to associate with each other to form the downstream path of the communication session and instruction the second node and/or the client device to associate with each other to form the upstream path data of the communication session. Separating the transmit and receive links in the single communication session enables the client device to transmit via the optimal transmit node(s) and receive via the optimal receive node(s), even if the optimal transmit node(s) and optimal receive node(s) are different, thereby maximizing throughput and/or capacity while minimizing power consumption by the client device.

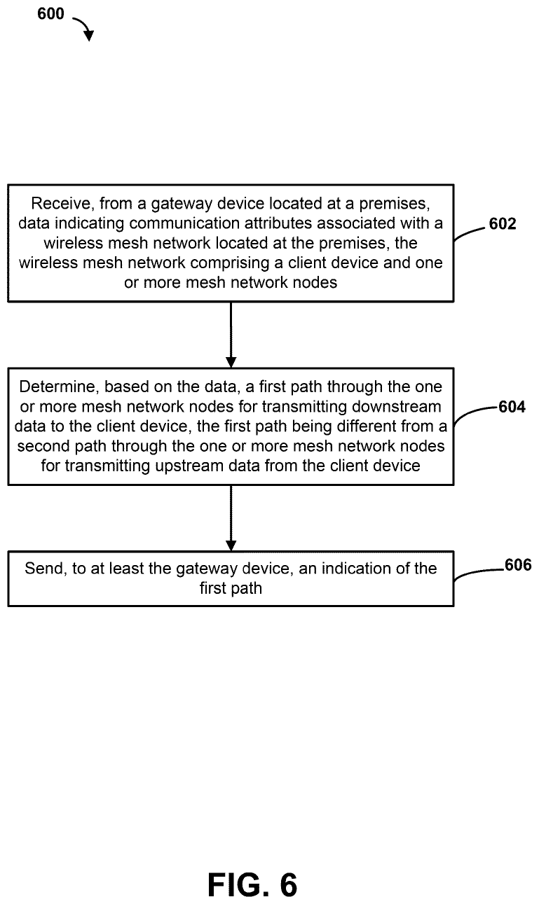

FIG. 6 is an example method 600. The method 600 may comprise a computer implemented method for network optimization. A system and/or computing environment, such as the system 100 of FIG. 1 and/or the computing environment of FIG. 8, may be configured to perform the method 600. For example, the server device 102 of FIG. 1 may be configured to perform the method 600.

At 602, data indicating communication attributes associated with a wireless mesh network may be received. The data indicating the communication attributes associated with the wireless mesh network may be received from a gateway device of a network. The wireless mesh network may be located at a premises. The data indicating the communication attributes associated with the wireless mesh network may be received by a server device located external to the premises. The wireless mesh network may comprise a client device and one or more mesh network nodes. The one or more mesh network nodes may comprise the gateway device. The communication attributes may be associated with a location of the client device at the premises. The communication attributes may change (e.g., vary) as the client device is moved around the premises.

The communication attributes may comprise one or more of a signal-to-noise ratio (SNR) associated with each of the one or more mesh network nodes, a received signal strength indicator (RSSI) associated with each of the one or more mesh network nodes, transmit power level, neighboring access points, an 802.11 mode, data rates from each of the one or more mesh network nodes, data rates from the client device, modulation and coding scheme (MCS) rates associated with each of the one or more mesh network nodes, channel utilization, bandwidth, number of spatial streams (NSS), and/or responses to broadcast beacons associated with each of the one or more mesh network nodes.

At 604, a first path through the one or more mesh network nodes for transmitting downstream data to the client device may be determined. The first path through the one or more mesh network nodes for transmitting downstream data to the client device may be determined at a first time. The first path may be determined based on the data indicating the communication attributes associated with the wireless mesh network The first path may comprise the path through the one or more mesh network nodes for transmitting downstream data to the client device that maximizes throughput and/or capacity, given the location of the client device at the premises. The first path, determined at the first time, may be different from a second path through the one or more mesh network nodes that is being used, at the first time, for receiving upstream data from the client device. The second path may have been determined at a second time (e.g., prior to the first time).

At 606, an indication may be sent to at least the gateway device. The indication may comprise an indication of the first path. Sending the indication to the gateway device may cause the client device to receive downstream data of a communication session via the first path while sending upstream data of the same communication session via the second path. Separating the transmit and receive paths in the single communication session enables the client device to transmit via the optimal transmit path and receive via the optimal receive path, even if the optimal transmit path and optimal receive path are different, thereby maximizing throughput and/or capacity while minimizing power consumption by the client device.

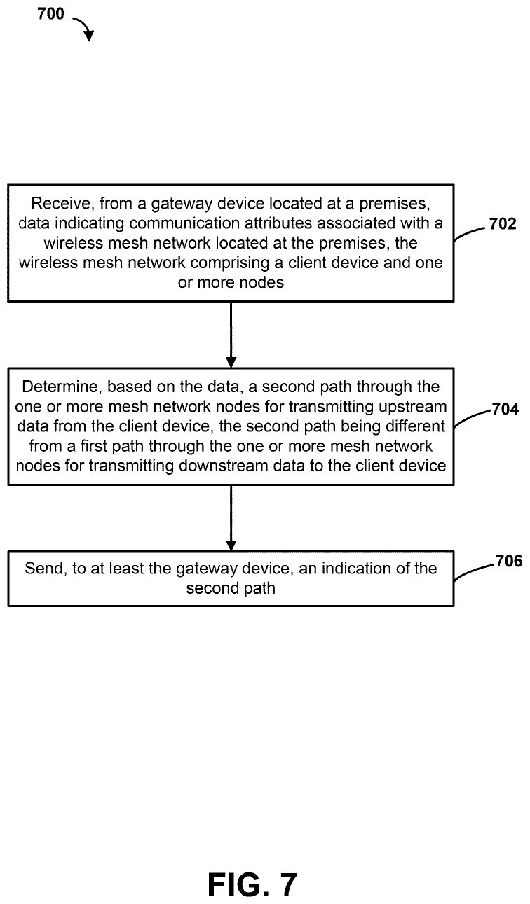

FIG. 7 is an example method 700. The method 700 may comprise a computer implemented method for network optimization. A system and/or computing environment, such as the system 100 of FIG. 1 and/or the computing environment of FIG. 7, may be configured to perform the method 700. For example, the server device 102 of FIG. 1 may be configured to perform the method 700.

At 702, data indicating communication attributes associated with a wireless mesh network may be received. The data indicating the communication attributes associated with the wireless mesh network may be received from a gateway device of a network. The wireless mesh network may be located at a premises. The data indicating the communication attributes associated with the wireless mesh network may be received by a server device located external to the premises. The wireless mesh network may comprise a client device and one or more mesh network nodes. The one or more mesh network nodes may comprise the gateway device. The communication attributes may be associated with a location of the client device at the premises. The communication attributes may change (e.g., vary) as the client device is moved around the premises.

The communication attributes may comprise one or more of a signal-to-noise ratio (SNR) associated with each of the one or more mesh network nodes, a received signal strength indicator (RSSI) associated with each of the one or more mesh network nodes, transmit power level, neighboring access points, an 802.11 mode, data rates from each of the one or more mesh network nodes, data rates from the client device, modulation and coding scheme (MCS) rates associated with each of the one or more mesh network nodes, channel utilization, bandwidth, number of spatial streams (NSS), and/or responses to broadcast beacons associated with each of the one or more mesh network nodes.

At 704, a second path through the one or more mesh network nodes for transmitting upstream data from the client device may be determined. The second path through the one or more mesh network nodes for transmitting upstream data from the client device may be determined at a second time. The second path may be determined based on the data indicating the communication attributes associated with the wireless mesh network. The second path may comprise the path through the one or more mesh network nodes for transmitting upstream data from the client device that maximizes throughput and/or capacity, given the location of the client device at the premises. The second path, determined at the second time, may be different from a first path through the one or more mesh network nodes that is being used, at the second time, for transmitting downstream data to the client device. The first path may have been determined at a first time (e.g., prior to the second time).

At 706, an indication may be sent to at least the gateway device. The indication may comprise an indication of the second path. Sending the indication to the gateway device may cause the client device to transmit upstream data of a communication session via the second path while receiving downstream data of the same communication session via the first path. Separating the transmit and receive paths in the single communication session enables the client device to transmit via the optimal transmit path and receive via the optimal receive path, even if the optimal transmit path and optimal receive path are different, thereby maximizing throughput and/or capacity while minimizing power consumption by the client device.

FIG. 8 is example computing device 800 that may represent any of the various devices or entities shown in FIG. 1, including, for example, the server device 102, the gateway device 104, the user device 106, and/or the plurality of nodes 110a-n. That is, the computing device 800 shown in FIG. 8 may be any smartphone, server computer, workstation, access point, router, gateway, tablet computer, laptop computer, notebook computer, desktop computer, personal computer, television, network appliance, PDA, e-reader, user equipment (UE), mobile station, fixed or mobile subscriber unit, pager, wireless sensor, consumer electronics, or other computing device, and may be utilized to execute any aspects of the methods and apparatus described herein, such as to implement any of the apparatus of FIG. 1 or any of the methods described in relation to FIGS. 3-7.

The computing device 800 may include a baseboard, or “motherboard,” which is a printed circuit board to which a multitude of components or devices may be connected by way of a system bus or other electrical communication paths. One or more central processing units (CPUs or “processors”) 804 may operate in conjunction with a chipset 808. The CPU(s) 804 may be standard programmable processors that perform arithmetic and logical operations necessary for the operation of the computing device 800.

The CPU(s) 804 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 804 may be augmented with or replaced by other processing units, such as GPU(s). The GPU(s) may comprise processing units specialized for but not necessarily limited to highly parallel computations, such as graphics and other visualization-related processing.

A chipset 808 may provide an interface between the CPU(s) 804 and the remainder of the components and devices on the baseboard. The chipset 808 may provide an interface to a random-access memory (RAM) 808 used as the main memory in the computing device 800. The chipset 808 may provide an interface to a computer-readable storage medium, such as a read-only memory (ROM) 820 or non-volatile RAM (NVRAM) (not shown), for storing basic routines that may help to start up the computing device 800 and to transfer information between the various components and devices. ROM 820 or NVRAM may also store other software components necessary for the operation of the computing device 800 in accordance with the aspects described herein.

The computing device 800 may operate in a networked environment using logical connections to remote computing nodes and computer systems of the system 80. The chipset 808 may include functionality for providing network connectivity through a network interface controller (NIC) 822. A NIC 822 may be capable of connecting the computing device 800 to other computing nodes over the system. It should be appreciated that multiple NICs 822 may be present in the computing device 800, connecting the computing device to other types of networks and remote computer systems. The NIC may be configured to implement a wired local area network technology, such as IEEE 802.3 (“Ethernet”) or the like. The NIC may also comprise any suitable wireless network interface controller capable of wirelessly connecting and communicating with other devices or computing nodes on the system 80. For example, the NIC 822 may operate in accordance with any of a variety of wireless communication protocols, including for example, the IEEE 802.11 (“Wi-Fi”) protocol, the IEEE 802.16 or 802.20 (“WiMAX”) protocols, the IEEE 802.15.4a (“Zigbee”) protocol, the 802.15.3c (“UWB”) protocol, one or more Bluetooth protocols, and/or the like.

The computing device 800 may be connected to a mass storage device 828 that provides non-volatile storage (i.e., memory) for the computer. The mass storage device 828 may store system programs, application programs, other program modules, and data, which have been described in greater detail herein. The mass storage device 828 may be connected to the computing device 800 through a storage controller 824 connected to the chipset 808. The mass storage device 828 may consist of one or more physical storage units. A storage controller 824 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 800 may store data on a mass storage device 828 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 828 is characterized as primary or secondary storage and the like.

For example, the computing device 800 may store information to the mass storage device 828 by issuing instructions through a storage controller 824 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 800 may read information from the mass storage device 828 by detecting the physical states or characteristics of one or more particular locations within the physical storage units.

In addition to the mass storage device 828 described herein, the computing device 800 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 800.

By way of example and not limitation, computer-readable storage media may include volatile and non-volatile, non-transitory computer-readable storage media, and removable and non-removable media implemented in any method or technology. However, as used herein, the term computer-readable storage media does not encompass transitory computer-readable storage media, such as signals. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other non-transitory medium that may be used to store the desired information in a non-transitory fashion.

A mass storage device, such as the mass storage device 828 depicted in FIG. 8, may store an operating system utilized to control the operation of the computing device 800. The operating system may comprise a version of the LINUX operating system. The operating system may comprise a version of the WINDOWS SERVER operating system from the MICROSOFT Corporation. According to additional aspects, the operating system may comprise a version of the UNIX operating system. Various mobile phone operating systems, such as IOS and ANDROID, may also be utilized. It should be appreciated that other operating systems may also be utilized. The mass storage device 828 may store other system or application programs and data utilized by the computing device 800.

The mass storage device 828 or other computer-readable storage media may also be encoded with computer-executable instructions, which, when loaded into the computing device 800, transforms the computing device from a general-purpose computing system into a special-purpose computer capable of implementing the aspects described herein. These computer-executable instructions transform the computing device 800 by specifying how the CPU(s) 804 transition between states, as described herein. The computing device 800 may have access to computer-readable storage media storing computer-executable instructions, which, when executed by the computing device 800, may perform the methods described in relation to FIGS. 3-7.

A computing device, such as the computing device 800 depicted in FIG. 8, may also include an input/output controller 832 for receiving and processing input from a number of input devices, such as a keyboard, a mouse, a touchpad, a touch screen, an electronic stylus, or other type of input device. Similarly, an input/output controller 832 may provide output to a display, such as a computer monitor, a flat-panel display, a digital projector, a printer, a plotter, or other type of output device. It will be appreciated that the computing device 800 may not include all of the components shown in FIG. 8, may include other components that are not explicitly shown in FIG. 8, or may utilize an architecture completely different than that shown in FIG. 8.

As described herein, a computing device may be a physical computing device, such as the computing device 800 of FIG. 8. A computing device may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems described herein are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes¬from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey data indicating a preferred or ideal embodiment. “Such as” is not used in a restrictive sense, but for explanatory purposes.

Components and devices are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable instructions (e.g., computer software or program code) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described above with reference to block diagrams and flowchart illustrations of methods, systems, apparatuses, and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described herein may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are shown as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the shown computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method comprising:
receiving, by at least one server device and from a gateway device of a network, data indicating wireless communication attributes associated with the network, wherein the network comprises a client device and one or more nodes;
determining, based on the data indicating the wireless communication attributes associated with the network, at least a first node of the one or more nodes for transmitting downstream data to the client device;
determining, based on the data indicating the wireless communication attributes associated with the network, at least a second node of the one or more nodes for transmitting upstream data from the client device; and
sending, to at least the gateway device, an indication of the first node and the second node, thereby to cause the client device to receive downstream data of a communication session via the first node and to send upstream data of the communication session via the second node.

2. The method of claim 1, wherein the second node is different from the first node.

3. The method of claim 1, wherein the wireless communication attributes associated with the network comprise one or more of: a signal-to-noise ratio (SNR) associated with each node of the one or more nodes, a received signal strength indicator (RSSI) associated with each node of the one or more nodes, neighboring access points, an 802.11 mode, data rates from each node of the one or more nodes, modulation and coding scheme (MCS) rates associated with each node of the one or more nodes, or responses to broadcast beacons associated with each node of the one or more nodes.

4. The method of claim 1, wherein the one or more nodes comprises the gateway device.

5. The method of claim 1, wherein the network is located at a premises and the at least one server device is located external to the premises.

6. The method of claim 1, wherein the network comprises a wireless mesh network.

7. The method of claim 1, wherein causing the client device to receive the downstream data of the communication session via the first node comprises causing the client device to receive the downstream data from the gateway device via the first node, and wherein causing the client device to send the upstream data of the communication session via the second node comprises causing the client device to send the upstream data to the gateway device via the second node.

8. The method of claim 1, wherein the client device comprises at least one of a mobile device, a smart phone, a tablet computer, a portable gaming device, or a wearable computing device.

9. A method comprising:
receiving, from a gateway device located at a premises, by at least one server device located remotely from the premises, data indicating communication attributes associated with a wireless mesh network located at the premises, wherein the wireless mesh network comprises a client device and one or more mesh network nodes;
determining, based on the data indicating the communication attributes associated with the wireless mesh network, at least a first path through the one or more mesh network nodes for transmitting downstream data from the gateway device to the client device; determining, based on the data indicating the communication attributes of the wireless mesh network, at least a second path through the one or more mesh network nodes for transmitting upstream data from the client device to the gateway device; and
sending, to at least the gateway device, an indication of the first path and the second path, thereby to cause the client device to receive downstream data of a communication session via the first path and to send upstream data of the communication session via the second path.

10. The method of claim 9, wherein the first path is different from the second path.

11. The method of claim 9, wherein the first path comprises at least one first mesh network node of the one or more mesh network nodes and the second path comprises at least one second mesh network node of the one or more mesh network nodes.

12. The method of claim 9, wherein the communication attributes associated with the wireless mesh network comprise one or more of: a signal-to-noise ratio (SNR) associated with each mesh network node of the one or more mesh network nodes, a received signal strength indicator (RSSI) associated with each mesh network node of the one or more mesh network nodes, neighboring access points, an 802.11 mode, data rates from each mesh network node of the one or more mesh network nodes, modulation and coding scheme (MCS) rates associated with each mesh network node of the one or more mesh network nodes, or responses to broadcast beacons associated with each mesh network node of the one or more mesh network nodes.

13. The method of claim 9, wherein the one or more mesh network nodes comprises the gateway device.

14. The method of claim 9, wherein the client device comprises at least one of a mobile device, a smart phone, a tablet computer, a portable gaming device, or a wearable computing device.

15. A method comprising:
receiving, from a gateway device located at a premises, by at least one server device located remotely from the premises, data indicating communication attributes associated with a wireless mesh network located at the premises, wherein the wireless mesh network comprises a client device and one or more mesh network nodes;
determining, based on the data indicating the communication attributes associated with the wireless mesh network, at least a first path through the one or more mesh network nodes for transmitting downstream data from the gateway device to the client device, wherein the first path is different from a second path through the one or more mesh network nodes used for transmitting upstream data from the client device to the gateway device; and
sending, to at least the gateway device, an indication of the first path, thereby to cause the client device to receive downstream data of a communication session via the first path.

16. The method of claim 15, wherein the first path comprises at least one first mesh network node of the one or more mesh network nodes and the second path comprises at least one second mesh network node of the one or more mesh network nodes.

17. The method of claim 15, wherein the communication attributes associated with the wireless mesh network comprise one or more of: a signal-to-noise ratio (SNR) associated with each mesh network node of the one or more mesh network nodes, a received signal strength indicator (RSSI) associated with each mesh network node of the one or more mesh network nodes, neighboring access points, an 802.11 mode, data rates from each mesh network node of the one or more mesh network nodes, modulation and coding scheme (MCS) rates associated with each mesh network node of the one or more mesh network nodes, or responses to broadcast beacons associated with each mesh network node of the one or more mesh network nodes.

18. The method of claim 15, wherein the one or more mesh network nodes comprises the gateway device.

19. The method of claim 15, wherein causing the client device to receive the downstream data of the communication session via the first path comprises causing the client device to receive the downstream data from the gateway device via the first oath.

20. The method of claim 15, wherein the client device comprises at least one of a mobile device, a smart phone, a tablet computer, a portable gaming device, or a wearable computing device.
